(19) United States
(12) Patent Application Publication
(10) Pub. No.: US 2010/0059902 A1
(43) Pub. Date: Mar. 11, 2010

(54) PROCESS AND APPARATUS FOR BUFFING GOLF BALLS

(76) Inventors: Thomas E. Moore, Warren, RI (US); Thomas L. Mydlack, Rochester, MA (US); Michael F. Vieira, Acushnet, MA (US)

Correspondence Address: ACUSHNET COMPANY, 333 BRIDGE STREET, P. O. BOX 965, FAIRHAVEN, MA, 02719, US

(21) Appl. No.: 12/206,049

(22) Filed: Sep. 8, 2008

(51) Int. Cl. B29C 37/02; B24B 5/36

(52) U.S. Cl. 264/161; 451/70

(57) ABSTRACT

A method and apparatus for automatically removing flash along the parting line of a golf ball, especially when the parting line is wavy or corrugated. The apparatus is also effective for removing flash from golf balls that are not completely spherical, or golf balls that are void of tabs or annular ring which are commonly used for alignment. The method removes flash from a golf ball by using a mapping device comprising either a vision orientation system or a laser means incorporating comprises high resolution CCD displacement sensors on a servo controlled vertical axis to properly place the ball in position wherein a cutter and buffer are maneuvered along a mapped contour of the flash that is captured by the coordinated motion logic of a computer.

### FIELD OF THE INVENTION

A process and an apparatus for buffing golf balls, specifically, the buffing of golf balls having wavy parting lines, or golf balls that are not completely spherical. More specifically, it relates to buffing of golf balls that do not have orienting aids such as tabs or annular rings.

### BACKGROUND OF THE INVENTION

Golf ball covers are generally formed in one of two ways. Either by molding hollow, semi-circular cover halves about a core, or by injection molding cover stock around a core. The molding of two semi-circular cover halves around a core is conventional and is generally accomplished by means of a frame containing a plurality of paired ball cup molds. Each ball cup mold bears a dimple pattern which is implanted on the cover halves when the frame is closed and the cover halves are subjected to heat and pressure, which cause the cover halves to join and form a solid, dimpled cover. Excess cover stock seeps out from between the pair of ball cup molds and interconnects the balls to form a matrix of balls, each ball being connected to its neighbors by the excess or overflow of cover stock.

Injection molding of golf ball covers is accomplished in a conventional manner by placing cores inside retractable pin ball cup molds and injecting cover stock around the core. Generally the ball cup molds are housed in a frame. The ball cup molds are such that cover stock can be forced into the ball cup molds through a runner system and form a matrix as described above. In either case, when the balls are detached from the matrix a ring of cover stock, a flash ring, remains, encircling the ball. This unwanted flash ring is generally removed by a buffing operation.

For the automatic buffing processes available today, in addition to annular flash rings, there are often “tabs” created purposely molded along the parting line by means of sprues (vents). Prior to vision orientation, “tabs” were necessary for the buffing process to allow for the proper orientation of the ball in a holding cup wherein they can be buffed with automatic machinery. However, there are some golf balls that are not properly finished in the buffing process, usually because the “tabs” or annular rings (needed for proper ball orientation) were either compromised in the failed buffing process or else inadvertently removed. These balls must then be manually buffed.

In the manual buffing procedure each ball is positioned into a rotating, holding fixture such that the material to be buffed is along a horizontal plane by a suitable device for orienting the balls which may be a vibrating or air blowing device. This is a conventional piece of equipment which has a ball cup for holding the ball to be buffed. The ball cup has a dimple pattern similar to that of the golf ball or a portion of the golf ball on the bottom and a security arm on top. The ball is placed in between the cup and the security arm, the cup being below the ball while the arm is above the ball. The ball is vibrated until the dimple pattern on the ball is aligned with the dimple pattern in the cup. The buffing process then brings a spinning, grinding wheel in a horizontal direction against the flash ring to grind away this unwanted material. If the wheel is held too long or pushed too hard against the ball, too much material is removed and the ball is left with a seam appearing as a flat band around the ball. If the wheel is not applied long enough, or without enough force, the flash ring is not sufficiently removed and remains on the ball. Both of these conditions are unacceptable.

The length of time and the amount of pressure with which the grinding wheel engages the ball is determined by the individual operator and varies from ball to ball. Also, this method of buffing does not solve the problem of buffing a golf ball having a wavy parting line without damaging/altering the edges of the dimples of the ball.

Another problem encountered in buffing procedures is when the ball is not a perfect sphere or it is a little larger or smaller in size. When buffing a larger ball, it sits higher in the cup therein raising the equator up and subsequently the height of the flash, and since the cutters and sanders are normally set at a fixed height, they will be off target and can remove too much material of the larger size balls or too little material of a smaller size balls. This can be a cause for a significant loss of product.

Removal of the flash ring can be accomplished by grinding, cutting, and/or sanding, mostly a combination of cutting and sanding. Preferably, a cutter is first used to remove part of the flash ring. Then, a continuous belt sander is used to remove the remaining excess material. In some applications two sanders are used, first a rough sander and then followed by a finer sander. In a most preferred embodiment, a brush is used to remove any remaining particles. Using a cutter prior to sanding insures that each remaining portion of the flash ring presented to the sanding stations is fairly uniform with respect to its distance of protrusion from the ball.

Buffing golf balls without the aid of “tabs” or annular flash rings to orient the ball is very difficult, especially if the ball is one that has a wavy or corrugated parting line. Even more difficult are finishing golf balls that are slightly out of size or are more oval in shape. For these golf balls a method is urgently needed that will automatically orient the golf balls, and then ascertain the thickness, length and location of the flash, and then remove it evenly from about the surface of golf balls by adjusting the cutting planes of the removal apparatus. Another problem is when the ball is significantly atypical of a perfect sphere.

These and other aspects of the present invention may be further understood from the following detailed description.

### SUMMARY OF THE INVENTION

It is the object of the present invention to provide a method and apparatus for automatically removing flash along the parting line of a golf ball. A still further objective is to remove flash along a parting line that may be wavy or corrugated, and/or which may lack the tabs or annular ring that help orient the ball, or is not completely spherical i.e. golf balls that may have varying diameters.

In accomplishing these and other objects, the present invention provides a method for automatically buffing a flash ring on a golf ball comprising the steps of: orienting the ball such that the flash is in a predetermined plane; identifying a location, length and thickness of the flash in relation to the ball by using a mapping device controlled by a computer's coordinated motion logic to capture and produce a mapped contour of the flash in relationship to the profile of the ball; removing the flash by an adjustable cutter that responds to the computer's coordinated motion logic to trace and cut the flash along the mapped contour profile of the ball; and buffing the golf ball with flexible profiled sanding belts.

In one embodiment of the invention the method utilizes a mapping device that comprises a vision orientation device such as shown in commonly owned U.S. Patent Publication No. 2005/0202886, which is incorporated in its entirety by reference herein.

In another embodiment of the invention the method utilizes mapping device that comprises high resolution CCD displacement sensors on a servo controlled vertical axis.

The invention includes: a supporting structure; a computer for providing coordinated motion logic; a vision orienting device for orienting the ball into a predetermined plane; a rotating spindle cup; a mapping device for providing a mapped contour of the flash in relationship to the profile of the ball and transmitting the data to a computer; the mapping device can be a vision system or a laser based system; an adjustable cutter that responds to commands received from the computer's coordinated motion logic to therein trace and cut the flash along the mapped contour profile of the ball; and a flexible sanding belt using profiled rollers to finish the ball.

### BRIEF DESCRIPTION OF THE DRAWINGS

FIG. 1 is a diagram showing exemplary steps according to the present invention;

FIG. 2 is a perspective top view of the apparatus;

FIG. 3 is a perspective view of the orientation device coordinating with the cutting and buffing devices:

FIG. 4 is a perspective view of the apparatus with high resolution CCD displacements sensors on a servo controlled vertical axis controlling the utter;

FIG. 5 is an elevated view of two different diameter golf balls seated in a spindle cup; and

FIG. 6 is a view of a golf ball having a wavy parting line.

### DETAILED DESCRIPTION OF THE DISCLOSURE

As previously discussed, buffing of flash about the surface of a golf ball can be accomplished by grinding, cutting, and/or sanding, and primarily it is a combination of cutting and sanding. It is common practice for many manufacturers to purposely mold a golf ball cover with tabs (usually about 10) on the parting line of the ball, the tabs aiding in the orientation of the ball for the de-flashing procedure. This is done by having “sprues” (vents) placed on the rim section of the mold parting surface, which is described in commonly owned U.S. Pat. No. 6,644,948, issued to Mydlack et al. which is incorporated in its entirety herein. While it may seem redundant to purposely add tabs, only then to have to remove them, tabs do help the automated equipment that is presently available to perform the buffing process. Even with tabs, a certain percentage of golf balls have the tabs or flash rings damaged or inadvertently removed in the molding and de-molding process. This percentage can be as high as 5%, and this may be a significant number. If the manufacturing process produces upwards of a million balls per day, this can result in 40,000 to 50,000 balls per day that must be manually buffed because they no longer have the necessary alignment tabs required by the automated buffing machinery. It also must be stated that manual buffing can be an extremely tedious chore. Typically, manual buffing is done by operators using manual buffing machines, wherein which each operator manually buffs balls continuously for an eight hour shift. This is a repetitive job with a high fatigue factor. The percentage of balls improperly buffed due to the operator holding the ball against the grinding wheel for either too short a period of time or for too long a period of time varies with the skill of each individual operator.

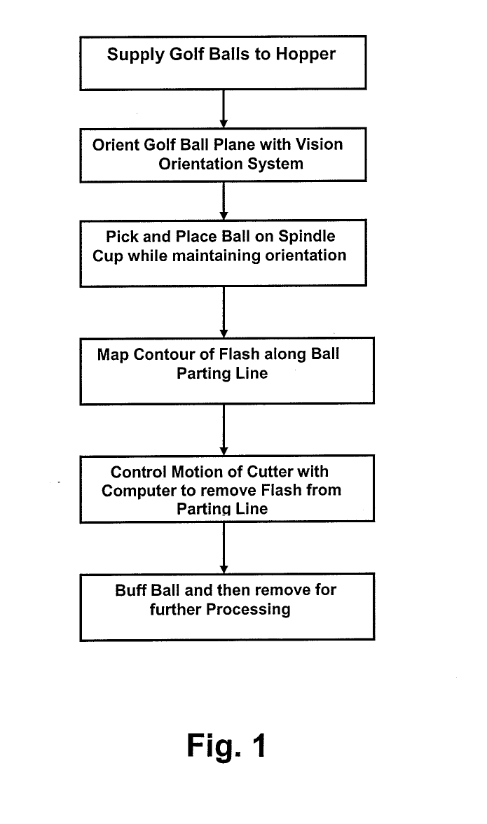

The present invention eliminates manual buffing by providing the apparatus and method to automatically buff golf balls that do not have the proper positioning tabs. The present invention also provides a process for automatic buffing of golf balls and making the addition of tabs or annular rings obsolete. This process is described in FIG. 1.

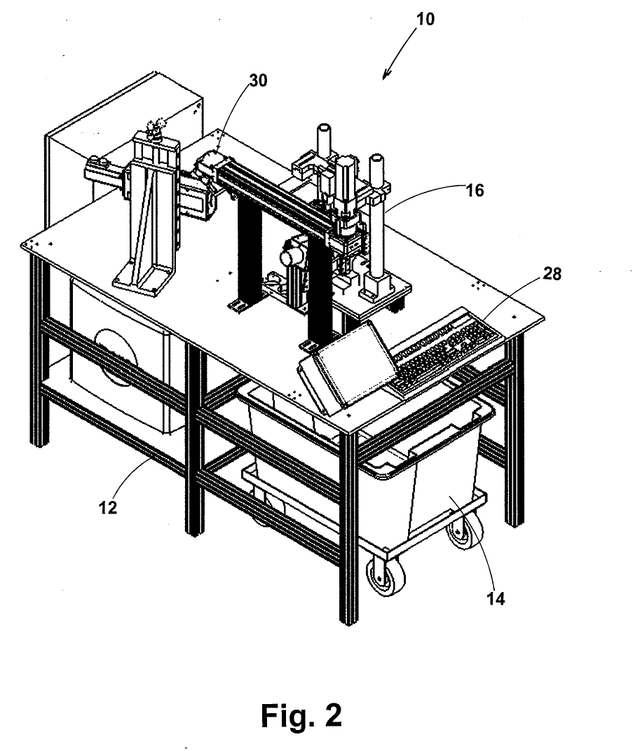

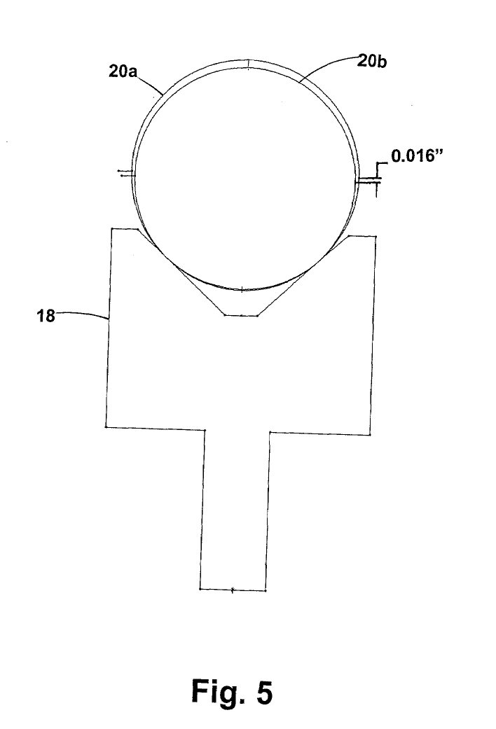

FIG. 1 is a schematic flow chart for the present invention method of buffing a golf ball without the aid of tabs. Shown on FIG. 2 is an apparatus 10 for automatically removing flash (excess material) that forms along the parting lines (seams) of golf balls during the molding step. The apparatus 10 includes: a support structure 12; a supply hopper 14; a vision orientation and mapping device 16 that orients the ball 20 to a correct plane orientation and creates a mapping of the flash contour which is fed to a computer 28; a pick and placement procedure which picks the ball from the vision orientation and mapping device 16 and exactly places the ball into a removable spindle cup 18 (see FIG. 5); each cup 18 holds a golf ball 20 which is rotated within the cup 18; the removal of the flash is accomplished by first, the mapping device 16 locating length and thickness of the flash and correlated this data in relationship to the profile of the ball 20 to the computer 28, which is then employed to map the coordinated motion logic of the ball profile produced; based on the mapped contour of the material on the parting line 26, as it relates to the profile of the ball 20, the computer 28 coordinates this data to direct the coordinates of an adjustable cutter 30 in such a manner that the cutter 30 will automatically respond to the mapped contour fed to it by the computer and therein only follow and cut only along the parting line profile provided to it. Thus, the need for tabs or annular flash rings to orient the balls properly for the buffing procedure is eliminated. The adjustable cutter 30 is profiled with a shape that significantly matches the desired profile of a golf ball, and has a leading sharp edge which is significantly angled in such a manner to facilitate the trimming off of all excess flash.

In one embodiment, the mapping device 22 comprises a vision orientation device as described and previously stated in the commonly owned U.S. Patent Application Publication No. 2005/0202886, which is incorporated in its entirety by reference herein. Mapping device 22 orients a golf ball by first acquiring an image of the ball at an imaging station, and then using a computer system analysis in which to orient the ball in a predetermined orientation according to the analysis.

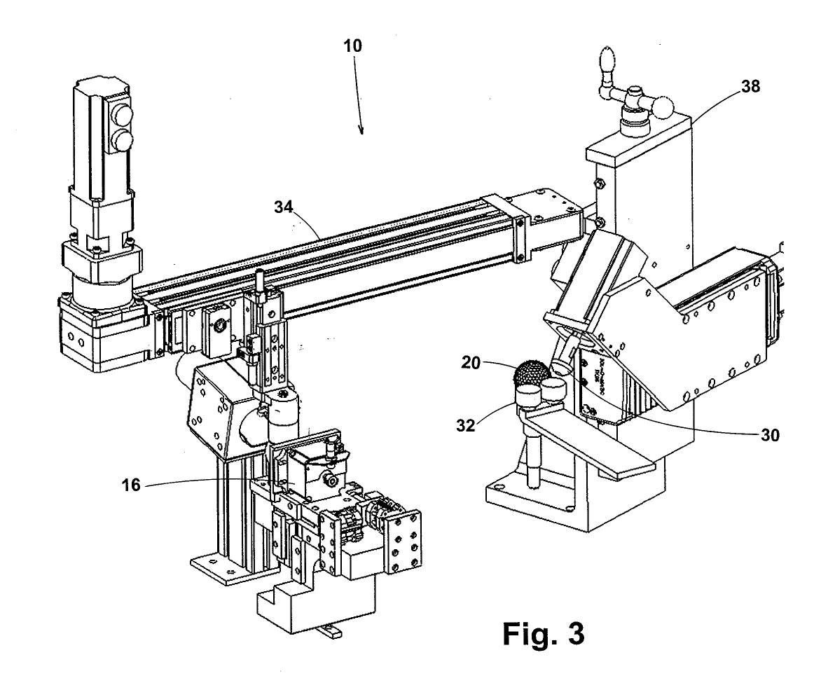

In FIG. 3, the relationship between the mapping device 16, and the cutter 30 is shown. Not shown is the pick and place mechanism for picking the ball 20 and placing it into the spindle cup 18, wherein it has the flash removed and then buffed by the spinning grinding wheels. The computer 28 uses the motion logic of the ball profile to adjust the cutter 30 for variations in ball geometry, whether that is because of varied ball diameter or varied shape (more oval). The computer controls a slider 34, which in addition to a horizontal motion, also has a vertical adjustment device 38, thus the cutter 30 can adjust for all golf balls presented to it, regardless of size or dimple arrangement.

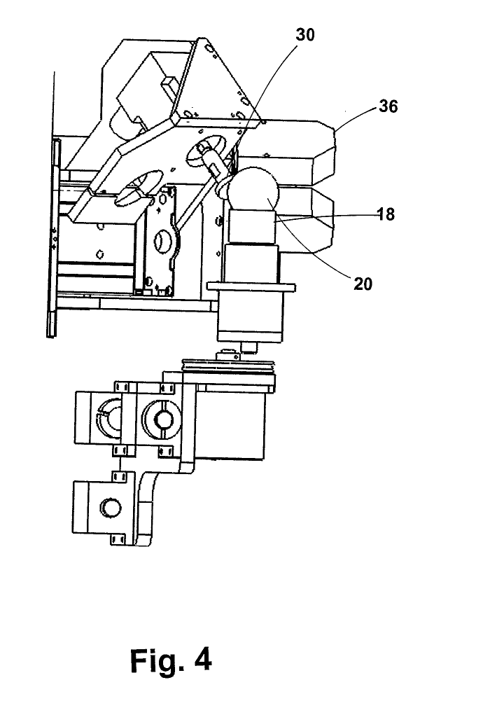

In another embodiment of the invention, the mapping of the ball profile may be performed by a laser type device 36 comprised of high resolution CCD displacement sensors on a servo controlled vertical axis, as described in FIG. 4. While there is prior art that teaches using lasers to cut flash, the present invention does not use laser technology to cut flash but rather to orient and locate the length and thickness of the parting line flash in relation to the profile of the ball 20. By relaying this data to the computer's coordinated motion logic of the ball profile, a mapped contour of the parting line 26 is produced by laser means. With this data supplied by the laser, the computer 28 then controls the adjustable cutter 30 in such a manner that the cutter follows and cuts only the flash as directed by the laser created analysis. The cutter 30 has a contoured cutting edge that is angled and compliments the shape of the ball profile.

As depicted in FIG. 5, when a ball 20 is larger 20a in diameter or more oval shaped, it will sit higher in the spindle cup 18. Conversely, if the ball is smaller 20b it will sit lower in the spindle cup 18. Since the golf balls are normally formed having maximum tolerances of about ±0.008 inch, this can mean a total difference of about 0.016 inch between an extremely large ball and extremely small ball. The problem encountered when attempting to buff golf balls that are out of round, or are of different shapes, or of varying sized diameters with prior art automatic buffing procedures, is that the cutters and sanders are positioned at fixed heights and fixed distances from the profile of the ball. As stated previously, if the ball is too small or too large, the cutters will not be lined up at the proper height and distance, and subsequently the buffing may produce a rejected ball. An example is when the cutter is set too high for small diameter balls, the cutter will tend to not cut deep enough, therein not removing enough of the flash material. And, for the large diameter balls, the cutters will cut too deeply into the ball, therein leaving an intolerable smooth band about the ball profile. With the recent development of “seamless” golf balls, a more significant problem is presented.

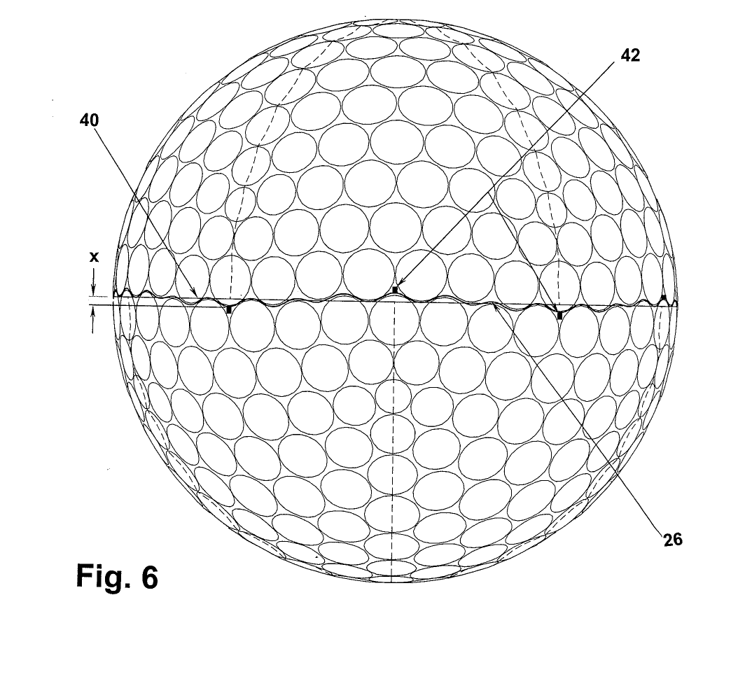

Cutting and buffing problems for the new “seamless” balls occur when a ball has a wavy parting line 26 such as shown in FIG. 6. This wavy parting line 26 allows for the interdigitation of dimples across the equator, which is a good thing because it allows for more dimple surface which is necessary for producing a high performance golf ball. FIG. 5 illustrates how the wavy parting line 26 may vary with the normal equator 40 of the ball 20. The amplitudes of the parting line can create a large variance x to which the cutter must adjust to during the cutting process. However, a buffing problem also arises because these dimples are located so close to each other along the parting line 26. Greater care is required during the buffing process to avoid damaging the dimple edges. The present invention provides a solution for this problem and allows for automatic buffing of all golf balls that previously had to be manually buffed. Although tabs are not necessary for the operation of the present invention, FIG. 5 depicts where tabs 42 might appear on the parting line of a ball.

It should be appreciated that the present invention apparatus and method allows for the manufacturer to produce golf balls without the need for the addition of tabs or annular rings. This can be a significant factor in lowering production costs and also facilitating the entire manufacturing process. Also, as previously stated, the dimples can molded closer together and thus more dimple space available which means a better performing ball. The tedious manual buffing procedure is eliminated along with the high cost associated manual procedures.

While it is apparent that the illustrative embodiments of the invention herein disclosed fulfill the objectives stated above, it will be appreciated that numerous modifications and other embodiments may be devised by those skilled in the art. Therefore, it will be understood that the appended claims are intended to cover all such modifications and embodiments which come within the spirit and scope of the present invention.

1. A method for automatically buffing flash off a golf ball comprising the steps of:
providing the golf ball from a supply hopper to an orientation device;
orienting the ball to a specific plane position;
identifying a location, a length and a thickness of the flash in relation to the profile of the ball by using a mapping device;
picking the golf ball and placing the ball into a rotating spindle cup without any change in the orientation;
providing a computer system having coordinated motion logic to capture the information from the mapping device and produce a mapped contour of the flash in relationship to a profile of the ball;
removing the flash by an adjustable cutter that responds to commands from the computer's coordinated motion logic and removes only flash along the ball profile;
buffing the golf ball with a flexible profiled sanding belt whose motion is controlled by the coordinated motion logic of the computer; and
removing the buffed ball from the spindle cup and forwarding it for further processing.

2. The method of claim 1, wherein the adjustable cutter comprises an angled and contoured cutting edge that compliments the profile of the ball.

3. The method of claim 1, wherein the mapping device comprises a vision orientation system.

4. The method of claim 3, wherein the vision orientation system positions a golf ball without alignment tabs.

5. The method of claim 3, wherein the vision orientation system positions a golf ball that is without an annular ring for alignment.

6. The method of claim 1, wherein the mapping device comprises high resolution CCD displacement sensors on a servo controlled vertical axis.

7. The method of claim 1, wherein the flash is located along a wavy parting line.

8. The method of claim 1, wherein the golf ball may be ±0.008 inch out of round.

9-15. (canceled)
